(19) United States
(12) Patent Application Publication
(10) Pub. No.: US 2024/0343024 A1
(43) Pub. Date: Oct. 17, 2024

(54) COMPOSITE BUILDING MATERIALS AND METHODS OF MAKING SAME

(71) Applicant: Wen Tang TSAI, Taichung City (TW)

(72) Inventor: Wen Tang TSAI, Taichung City (TW)

(21) Appl. No.: 18/633,348

(22) Filed: Apr. 11, 2024

Related U.S. Application Data
(60) Provisional application No. 63/458,503, filed on Apr. 11, 2023.

(51) Int. Cl. B32B 21/04; A47B 96/18; A47B 96/20; B32B 3/04; B32B 3/26; B32B 3/30; B32B 5/18; B32B 21/14

(52) U.S. Cl. CPC B32B 21/047; A47B 96/18; A47B 96/206; B32B 3/04; B32B 3/266; B32B 3/30; B32B 5/18; B32B 21/14; B32B 2260/021; B32B 2260/046; B32B 2266/0264; B32B 2479/00

(57) ABSTRACT

The present invention provides a wood substitute material made from recycled polyethylene terephthalate (PET) covered in a polywood-type veneer. The wood substitute material is a durable, eco-friendly, and cost-effective alternative to wood. Additionally, the wood substitute material is distinguishable in that it has insulating properties. Constructed thermoplastic polymer layers may be combined to be used in various applications such as furniture, cabinetry, shelving, countertops, construction, flooring, and as a substitute for wood in other wood-based products. Construction and creation of these materials provides a solution to the growing problem of deforestation and the increasing numbers of plastic products filling the world's landfills.

### CLAIM OF PRIORITY

The present application includes subject matter disclosed in and claims priority to a provisional application entitled “Composite material including a thermoplastic polymer resin, a wood-like thermoplastic elastomer, and a polyester-based adhesive” filed Apr. 11, 2023 and assigned Ser. No. 63/458,503, describing an invention made by the present inventor, herein incorporated by reference.

### FIELD OF THE INVENTION:

The present invention relates to compositions and constructions of structural, facing, and insulation material. More particularly, the present invention is directed to a composite organic material for building and construction, and method of making same.

### BACKGROUND OF INVENTION:

Montana Enterprise Co., Ltd. of Taiwan was established in 1991, as a trading agent for sourcing and export/import. Montana now manufactures and/or exports: skateboards and longboards (both wood and plastic version); inline and quad skates; protective gear, including helmets and pads (knee, elbow pads and wrist guard) for action sports (such as bicycles, skateboarding, skating, etc.); water sports epoxy surfboard, SUP and inflatable SUP & mats, towable tubes, wakeboards, etc.; softball, baseball, soccer, and training goal nets; boat anchors; tie-downs; baby strollers and car seats, etc. Montana utilizes the latest technologies in injection molding, die casting (aluminum parts), pouring (PU wheels), sewing, bending/stamping, etc.

Wood has been a construction staple for both indoor and outdoor building projects throughout history. Wood is an ideal building material due to its durability, longevity, density, strength, rigidity, and the ease with which it can be cut and shaped into a variety of configurations and sizes. Wood may be cut into beams of two-by-fours, one-by-tens, plywood, trim board, and the like, composited into particle boards, and furthermore different pieces of lumber can be easily attached with glue, nails, screws, bolts, and other fastening means.

Natural wood, derived from trees, is versatile; having extensive applications including but not limited to fence construction, building construction, shed construction, decking material, flooring material, and material for indoor/outdoor furniture. For example, woods such as oak, maple, and pine have traditionally been used for indoor cabinetry, flooring material, and furniture products. Cedar and teak are suitable for patio furniture, for both indoor and outdoor use. Other forms of wood constructs, such as particle board, may provide one-or two-dimensional strength, but have not bee useful for three-dimensional structural projects.

While trees are a renewable resource, the current demand for wood and other tree products is causing deforestation at a rate higher than trees can reproduce. Additionally, the shortage of trees contributes to global warming, as there are fewer trees to absorb the excess carbon dioxide. Due to concerns of deforestation, global warming, and other environmental issues relating to the shortage of trees, there is an ongoing attempt to create wood substitutes from materials such as plastics and concrete. While plastics have some favorable properties such as moldability and high tensile strength, traditional plastic wood replacements generally have a lower bending strength than hardwood, a lower creep performance than wood, and a linear thermal expansion coefficient larger than wood. Concrete, on the other hand, is a potential wood substitute due to its extremely high compressive strength and flexural modulus. Yet, it is still a subpar replacement because it is brittle, with low toughness and low deflection properties. Other polymer-based replacements, such as CELLWOOD® by Ply Gem or Mastic Home

Exteriors, Inc., offer an eco-friendly alternative to natural wood. CELLWOOD, and products similar, referred herein generally as polywood, consists of thermoplastic elastomers, without relying on any wood flour or wood dust fillers. Polywood provides the benefits of plastics such as water resistance, moldability, and high tensile strength, while also supplying the durability, longevity, strength, rigidity, insulation properties, and machinability of natural wood.

Furthermore, it boasts a coefficient of thermal expansion closer to that of natural wood. Still, polywood is not recommended for use as a main construction material, nor does it offer acceptable insulation properties. Additionally, the cost of polywood products is currently approximately 25% less than installations with real wood, per square foot. While polywood is more cost-effective, it is still not significantly cheaper than wood. Therefore, a more affordable alternative, boasting a broader range of applications while still providing the benefits of polywood is necessary.

Described herein is an affordable alternative to polywood, that also provides an avenue for recycling the plastic waste that currently pollutes landfills and chokes oceans, lakes, and rivers. Eight point three billion metric tons of plastic have been produced since plastics were introduced in the nineteen fifties, but only nine percent of plastics are ultimately recycled. Additionally, when plastics pollute landfills, they release toxic chemicals, contaminate the soil and waterways, and enter the food chain. The present invention presents a novel method for coating a recycled plastic filling with a polywood veneer to create an eco-friendly, affordable, wood alternative that reuses existing plastics rather than allowing them to continue polluting the environment.

In addition to recycling excess plastics, eco-friendliness is also beneficial, and some embodiments disclose a thermal insulator embodiment, promoting energy efficiency when used as building siding, roofing, or other construction material. Generally, buildings are constructed with decorative siding, such as CELLWOOD, for visual appeal, house wrap to prevent moisture and water from damaging the wood, and insulation to shield the inside of the building from the outdoor temperatures. Generally, insulation is either placed between studs or along the interior of the building, detracting from valuable square footage. It would be preferable to provide one product that may function as decorative siding, house wrap, and insulation.

It is a further goal to provide an alternative to traditional insulation methods. Rather than insulating a building from within, systems disclosed can be used to insulate, waterproof, and decorate a building from the outside in a single, easy-to-work-with, light, affordable layer. Offering maximum insulation, without compromising square footage, and eliminating the need for separate siding, house wrap, and insulation.

### SUMMARY OF THE INVENTION:

The present invention is directed to a synthetic building material that simulates a wood product is herein disclosed. Due to its synthetic nature, the product is suitable for use in harsh environments such as the kitchen, bathroom, and outdoors in the sun, rain, and snow.

The material can be formed by encasing one or more recycled plastic materials, which can easily be fabricated into various shapes such as elongated boards, as well as other geometric shapes such as oval, polygonal, circular, and the like. The materials may be laminated with similar or dissimilar products. An external layer, or other similar veneer, may be used to provide a preferred color or textured finish. The final product may incorporate reinforcement elements such as long fiber reinforcements to enhance its mechanical strength. In some embodiments, to decrease the weight of the materials, a blowing agent may be blended with the plastic material during the recycling process. In some embodiments the recycled plastic material assumes the form of a smooth foam at the end of the recycling process, augmenting the product's insulation properties.

In some embodiments, the veneer may be entirely thin film wrapped around the recycled plastic material. In other embodiments, individual sheets of the veneer can adhere to one or both sides of the recycled plastic assembly. The veneer may be attached to the recycled plastic material in a variety of ways, including but not limited to epoxy resin and polyester adhesives. Additionally, in some embodiments, single-layer veneer sheets are layered on top of each other to create a thicker product. The veneer sheets can be attached using heat compression or with glue containing toluene solvents.

In one embodiment material may be used to fabricate cabinets including, but not limited to, partial overlay, full overlay, and inset cabinets. Such fabrications have the advantage of being strong enough to support hundreds of pounds while being lightweight enough for easy self-installation. Additionally, durable, scratch resistant, and waterproof, material is ideal for use in wet, messy spaces such as kitchens and bathrooms. Due to its strength and the ease with which it can be installed, systems disclosed may also be assembled into shelving, including but not limited to shelving in damp, moist locations such as in showers, under sinks, outdoors, and in bathrooms and kitchens. Supporting shelves may include solid material (either homogenous or heterogenous), with conglomerate recycled plastic core, and may include a solid veneer on the top and bottom. An optional laminate or veneer may be applied to one or more edges. The structural walls and top/bottom are preferably made from a foamed panel that may include a veneer on one side, and a laminate on the exterior side(s), or laminate on both sides. Edges of structural boards may also be improved/aesthetically presented. A face or face panels or plates (and doors) may be made of a complete solid material, and/or may also include a conglomerate core. Wood veneer is preferably applied to the face (and doors). Doors are preferably one sold material, that may include veneer or laminate. Colorant or dyes may be added to the polymer/plastic during manufacture to provide preferred coloration, or paint may be applied to one or all surfaces. One or more sections may be made with wood or other known materials. The various panels may be adhered one another with adhesive (as discussed below) or heat compression.

In another embodiment, material may be used to produce skateboard decks with a controlled flex system. Such fabrications are ideal because the final product is lightweight, structurally strong, fire-resistant, and UV-inhibited. Additionally, the product is stiff enough to avoid damage, yet flexible enough to absorb impact. The product holds its shape well, producing a satisfactory skateboard “pop”. A single solid layer may be used, or more preferably a multiple, two, three, five, or up to fourteen layers may be presented. Each layer may be comprised of a different material, but preferably a solid material is used for most/all pieces/layers. The layers may be of different thickness, with a central conglomerate panel may be thicker than others. One or more adhesives may be used between the layers such as to provide more flexibility, pop, or sturdiness.

A further embodiment of the present invention is construction material. Material may replace plywood or particle board for structural framing, and other construction uses. Disclosed material is particularly suited as a plywood replacement due to its strength, thickness, durability, water resistance, and rigidity. Material may also function as a replacement for a variety of construction needs including, but not limited to, nonstructural studs, doors, baseboards, deck and railing systems, and baseboards due to its water-resistant, strong, scratch-resistant nature. Panels may be of one or more materials structures. Preferably, recycled conglomerate materials form one or more layers of a single board.

Material may also function as an outdoor lumber replacement. Such material is uniquely suited for use as decorative outdoor lumber due to its waterproof, weather-resistant, heat and cold-resistant nature. Because the material can be fabricated in any color, it does not need to be painted. Additionally, its insulation properties allow it to be used as both an insulator and decorative outdoor sheathing, removing the need for traditional insulation and house wrap. Furthermore, because of the various coating options the material may serve as roofing material including, but not limited to, roof shingles, roof tiles, or roof sheets coated with mylar or other such materials to function as both roofing and solar panels.

### BRIEF DESCRIPTION OF THE DRAWINGS:

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a cross-section view of an embodiment of the present invention illustrating the smooth foam recycled filling encased in a wood-like veneer.

FIG. 2 illustrates an embodiment of a cabinet used with the present materials.

FIG. 3A is an embodiment of the smooth foam recycled filling.

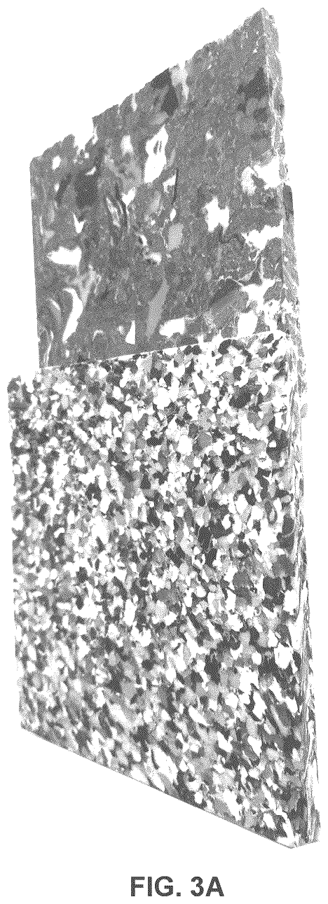

FIG. 3B is an embodiment of the smooth foam recycled filling.

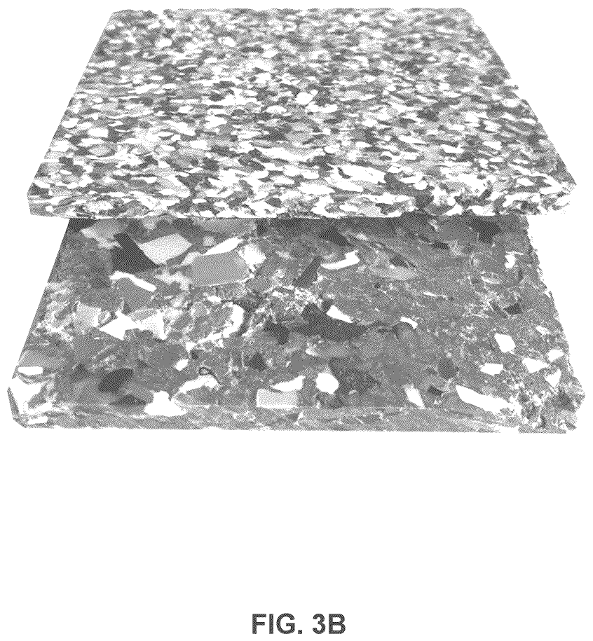

FIG. 4 is a view of an embodiment of the smooth foam recycled filling encased in a veneer.

FIG. 5 is a top view of an embodiment of the smooth foam recycled filling encased in a veneer.

FIG. 6 is a perspective of an embodiment of the smooth foam recycled filling encased in a veneer.

FIG. 7 is a view of a cross-section of an embodiment of the smooth foam recycled filling encased in a veneer.

### DETAILED DESCRIPTION:

### General Components

In describing the preferred embodiments of the invention, specific terminology will be used for the sake of clarity. However, the invention is not intended to be limited to the specific terms so selected, and it is to be understood that each specific term includes all technical equivalents that operate similarly to accomplish a similar purpose.

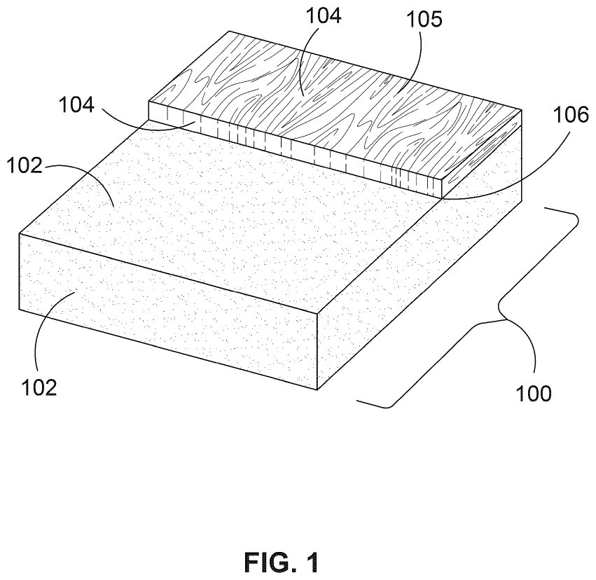

Referring to the drawings, wherein like reference numerals represent like elements, there is shown in FIG. 1 a section of an elongated board or plank constructed in accordance with one embodiment of the present invention, and designated generally as reference numeral 100. The board 100 is comprised of an inner recycled plastic filling 102 with the recycled plastic filling encased in a wood-like veneer 104 with three-dimensional texture 105. Texture may include regular or irregular groove pattern (e.g. to simulate wood grain), cross-hatching, pitting, or the like. In some embodiments, the recycled plastic filling 102 is a smooth foam. The recycled plastic smooth foam filling 102 possesses suitable characteristics for its intended use. Such characteristics include but are not limited to its strength, rigidity, water resistance, low thermal conductivity, weightlessness, and minimal thermal expansion. Plastic materials and mixtures thereof which possess suitable characteristics for useful materials include but are not limited to polyethylene terephthalate (PET), polyethylene (PE), polypropylene (PP), and polyvinyl chloride (PVC). A preferred material for the recycled smooth plastic foam filling may be PET.

Recycled plastic smooth foam 102 can be made using the following traditional extrusion techniques. Foam is preferably comprised of a density ranging from approximately three to thirty pounds per cubic foot, with bubble sizes preferably uniform or within three hundred percent size relative to one another. In some embodiments, cleaned PET may first be shredded into small flakes. The small flakes may then be melted and extruded through a die to form a continuous sheet. In some embodiments, the sheets may range in thickness from approximately between three millimeters to approximately seven centimeters. The extruded sheet may then be expanded into a foam using a blowing agent including, but not limited to, pentane, carbon dioxide, nitrogen, hydrocarbon, ketones, or an alcohol. The expanded foam may be cooled, such as by passing the foam through a water bath until its shape and structure are set. Once the foam is properly cooled, the foam may be cut into the desired shape and size using a specialized plastic cutting machine. In some embodiments, thermoset polymer materials may be molded into predetermined shapes. Thus, it should be understood that a wide variety of synthetic polymer materials may be used in constructing the materials.

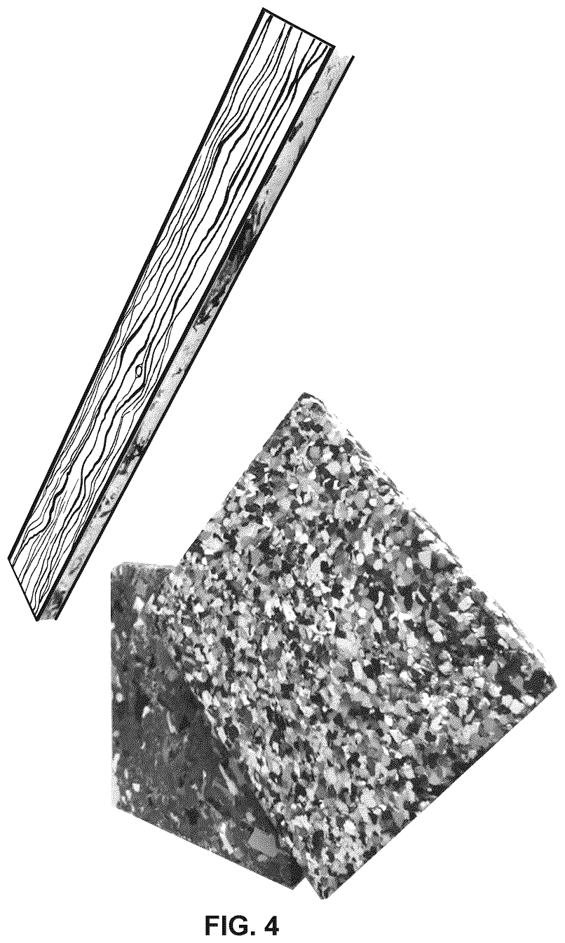

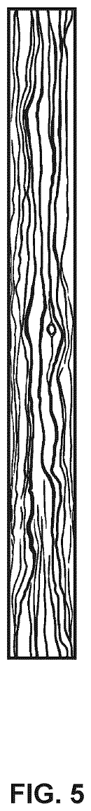

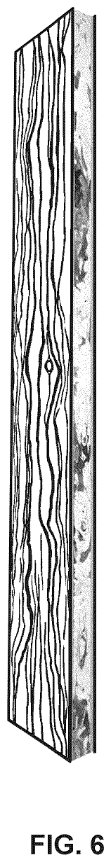

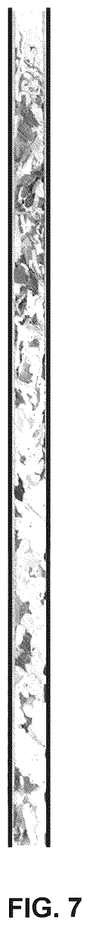

As seen in FIG. 4, FIG. 5, FIG. 6, and FIG. 7, the wood-like veneer covering the recycled plastic smooth foam may be fashioned from polywood. The veneer may alternatively or additionally include natural wood, particle board, and wood-plastic composite materials or laminates. polywood is a thermoplastic elastomer product that is non-toxic, heavy metal free, and formaldehyde free. It has wood like properties, is particularly scratch-proof and dent resistant, and is recyclable and reusable. By coating the recycled PET foam with polywood the strength, affordability, and insulation properties of the foam are complemented by the aesthetic, waterproof, and durable properties of polywood.

Recycled PET Making Process:

The following processes are illustrative in nature and are not intended to limit the process of producing polyethylene terephthalate (PET) foam in any way.

After recycled PET containers are chopped into flakes, the pure PET flakes must be separated from flakes containing impurities, and from other debris mixed into the flakes. In some embodiments, the recycled PET is derived from post-consumer containers. Bales of clear and mixed-colored recycled post-consumer PET containers obtained from various recycling facilities may make up the post-consumer PET containers for use in the process. In other embodiments, PET bottles may be collected through “curbside” recycling pickup programs. Sometimes, the source of the post-consumer PET containers may be returned ‘deposit’ bottles. The curbside or returned “deposit” bottles may contain a small level of non-PET contaminants. The contaminants in the containers may include but are not limited to, non-PET polymeric contaminants such as Polyvinyl Chloride (PVC), Polylactic acid (PLA), Polypropylene (PP), Polyethylene (PE), Polystyrene (PS), Polyamide (PA), etc. The contaminants may also include, but are not limited to, ferrous and non-ferrous metal, paper, cardboard, sand, glass, or other materials that may find their way into recycling bins. The non-PET contaminants may be removed from the desired PET components through various processes including but not limited to one or more of the processes described below.

One process for removing contaminants involves removing smaller components and debris from the whole bottles via a rotating trammel. Various metal removal magnets and eddy current systems may be incorporated into the rotating trammel to remove any metal contaminants. Near Infra-Red optical sorting equipment such as the National Recovery Technologies, LLC (NRT) Multi Sort IR machine or the SpydIR® machine may also be utilized to remove any loose polymeric contaminants that may be mixed in with the PET flakes. Additionally, automated X-ray sorting equipment may be utilized to remove remaining PVC contaminants.

Once the PET flakes are properly separated from impurities, the flakes are washed via a series of wash tanks. In some embodiments, the wash tanks are also used to clean olefin bottle cap residue from the PET flakes, as PET has a higher specific gravity than the olefin bottle caps. In some embodiments, the flakes are washed in a caustic bath and heated to about one hundred ninety degrees Fahrenheit. The caustic bath may be maintained at a concentration of between about zero-point six percent to about one point two percent sodium hydroxide. In some embodiments, soap surfactants, as well as defoaming agents, are added to the caustic bath, to further increase the separation and cleaning of the flakes. A double rinse system then washes the caustic solution from the flakes.

To dry the flakes, a centrifuge may be used to remove the water. The flake may then be dried with hot air to remove any surface moisture. The resultant “clean flakes” may then be processed through an electrostatic separation system and a flake metal detection system to remove any metal contaminants that remain on the flakes. In some embodiments, an air separation step may be used to remove the remaining labels from the clean flake. Additionally, an electro-optical flake sorter may perform the final polymer separation to remove any non-PET polymers or metal contaminants that persist.

In a preferred embodiment, the combination of these steps delivers substantially clean PET bottle flakes comprising less than approximately fifty parts per million PVC and less than approximately fifteen parts per million metals for use in the extrusion process.

In some embodiments, after the flakes are washed, they may be fed down a conveyor and scanned with a high-speed laser system. Such laser systems include but are not limited to lasers configured to detect contaminants such as PVC and aluminum. Flakes that are identified as containing remaining contaminants may be blown from the stream of flakes with air jets. In some embodiments, the resulting level of non-PET flakes is less than twenty-five ppm.

In some embodiments, it is preferable that the flakes are substantially free of water. In such embodiments, the flakes may be placed in a system where the flakes are blown with air for twenty to forty minutes. In some embodiments, it is preferable that the flakes be blown for thirty minutes, thereby removing any remaining surface water from the flakes. In other embodiments, the aforementioned water-removing step can be skipped, and the wet flakes may be fed directly into the extruder.

An extruder may be used to convert the flakes into the PET foam filling. When performing extrusion, the flakes are heated and pushed through a die, molding the melted flakes into the desired shaped foam.

In some embodiments, an extruder is used to turn the wet flakes described above into a molten recycled PET polymer and to perform several purification processes to prepare the polymer to be turned into smooth foam. In some embodiments, wet flakes are fed into a

Multiple Rotating Screw (“MRS”) extruder. In other embodiments, the wet flakes are fed into any other suitable extruder, including but not limited to, a twin-screw extruder, a multiple screw extruder, a planetary extruder, or any other suitable extrusion system. A particular example of such an MRS extruder is described in the U.S. Published Patent Application 2005/0047267, entitled “Extruder for Producing Molten Plastic Materials”, which was published on Mar. 3, 2005, and which is hereby incorporated herein by reference.

The wet flakes may be fed directly into the extruder immediately following washing, so long as the extruder includes a vacuum component during the melting step. Feeding the wet flakes directly into the Extruder immediately following washing may consume approximately twenty percent less energy than a system that pre-dries the flakes before extrusion. Additionally, feeding the flakes into the extruder while wet may save approximately eight hours, as the flakes that approximately eight hours to fully dry.

When using an extruder, the flakes may first be fed into the extruder and subsequently melted through heat and mechanical shearing. For PET a preferred melting temperature is two hundred six degrees Celsius. The flakes may be fed into the feed barrel from a hopper. In some embodiments, if reinforcing fibers are to be incorporated to the final product, the fibers may be added to the feed barrel at this point as well. The reinforcing fibers may be added in the form of chopped fibers, continuous fibers, or woven fabrics. Recycled plastic fiber can be classified into many types, including recycled polypropylene (RPP) fiber, recycled polyethylene terephthalate (RPET) fiber, recycled polyvinyl chloride (RPVC) fiber, recycled nylon fiber, recycled low-density polyethylene (RLDPE) fiber, recycled high-density polyethylene (RHDPE) fiber and recycled metallized plastic (RMP) fiber. The Recycled plastic fiber may be added to the foamed thermoplastic polymer resin.

As the flakes are fed into the feed barrel, a screw or multiple screws within the feed barrel drive the flakes forward while rotating them. The flakes may melt as they are driven forward by the screws, both due to the frictional heat created when the plastic molecules slide over each other and due to external feeding bands. Once the melted material reaches its final temperature it may be fed through a die, such that the melted material may be shaped into its desired form.

A preferred extrusion method is profile extrusion, wherein the melted material is fed through a die into a cooling trough filled with cold water. The product solidifies and cools in the water. At the end of the cooling trough, a haul-off pulls the product away from the die at a uniform, controlled, speed. The product is then cut to its desired size by a shearer. The resulting product is an embodiment of a suitable filling or inner layer.

### Producing a Recycled PET Smooth Foam

To increase the insulation properties, and to decrease the weight of the final product, PET may also be recycled into foam boards. The process for extruding PET into foam boards is similar to the plastic recycling process detailed above. Basic foam extrusion may involve mixing a chemical foaming agent, as is known in the art, with the polymer, preferably PET flakes, to be extruded. The heat generated to melt the polymer decomposes the chemical foaming agent resulting in a release of gas from the chemical foaming agent. This gas is dispersed throughout the polymer melt and expands upon exiting the die.

Most common extruders can be used to produce smooth foam, so long as the melt reaches temperatures high enough to guarantee a complete decomposition of the foaming agent, and the melt maintains a pressure high enough to keep the gas dissolved in the melt until the melt exits the extrusion die. To ensure that the gas does not escape from the extruder, the vent opening may be sealed. If the melt temperature is too low, the decomposition of the foaming agent will be incomplete, resulting in waste. Additionally, un-decomposed foaming agent particles can lead to agglomerates, which can clog the melt filter, cause voids, poor cell structure, or poor surface appearance in the final product. Furthermore, low pressure can lead to “prefoaming”. If pressure is subsequently increased to remedy low pressure, the gas cannot be “re-dissolved”, and the final product will include a large irregular cell structure with broken and collapsed cells. If properly extruded, the final smooth foam product may function as a superior alternative to wood, as it offers superior insulation properties, with boards that are 6-inches thick providing an R-value of thirty (R-value is the temperature difference per unit of heat flux needed to sustain one unit of heat flux between the warmer surface and colder surface of a barrier under steady-state conditions, as is known in the art).

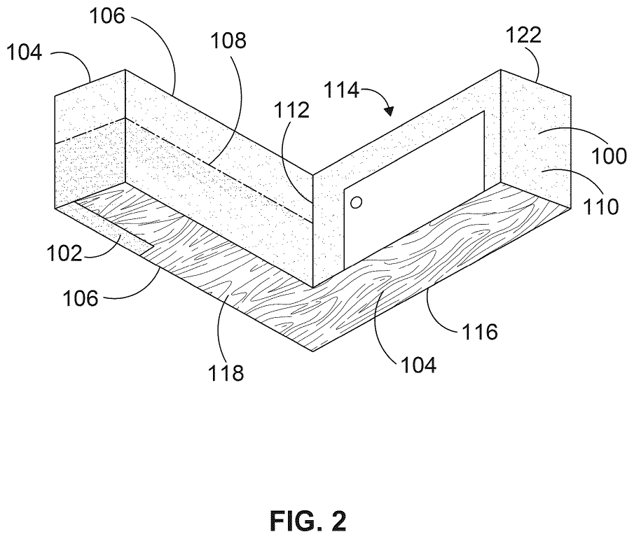

The smooth foam product may function as a satisfactory wood replacement; for example, for use as material for cabinets (as seen in FIG. 2), shelving, indoor and outdoor construction, skateboards, doors, exterior trim, plywood, roof tiles, and solar panels. In some embodiments, the smooth foam product may be a particularly suitable wood replacement due to its lightweightness. Additionally, in such embodiments the smooth foam product may have a tensile strength of three hundred five PSI (give or take 15 PSI), a tensile modulus of ten point 9 KSI (kilopound per square inch) (give or take 100 PSI), a compressive strength of one hundred thirty nine PSI (give or take ten PSI), a compressive modulus of eight point two seven KSI (give or take 100 PSI), a shear strength of seventy nine point eight PSI (give or take 7 PSI), and a shear modulus of two point one eight KSI (give or take 100 PSI). Furthermore, in a preferred embodiment, the smooth foam product may be compatible with traditional wood machining tools.

### Covering the Recycled Plastic With a Wood-like Veneer

As seen in FIG. 1, FIG. 4, FIG. 5, FIG. 6, and FIG. 7, the recycled plastic product may be encapsulated in a wood-like veneer 104. It is preferable that the product be encapsulated after the smooth foam cools. A preferred veneer may be polywood. The final product is preferably peel-proof, waterproof, and will not be damaged by the sun or harsh weather conditions. The materials tend to have minimal thermal-expansion and may have very similar coefficients of expansion as neighboring layers. By laminating the polywood veneer 104 over the recycled plastic filling 102 with glue 106 including, but not limited to, polyester series adhesives or epoxy resin the two materials fuse seamlessly and are, for all practical purposes, inseparable.

Additionally, for increased flexibility, multiple single sheets of veneer may be layered over recycled plastic filling 102. The veneer sheets may be attached via heat compression or with a toluene solvent-based glue.

In some embodiments, each face of the recycled plastic product is separately covered by a veneer. Each face may be individually covered with glue, preferably polyester series adhesives or epoxy resin, and then subsequently laminated by a sheet of veneer. In other embodiments, the veneer may be thin film wrapped around the entire plastic product. The process of thin film wrapping the veneer involves wrapping a thin layer of the veneer around a plurality of faces. In some embodiments, before lamination, the veneer is preferably heated to its softening point, thereby increasing the veneer's malleability. Polywood, for example, should be heated to approximately ninety degrees Celsius. After the veneer is heated glue 106, preferably either polyester series adhesives or epoxy resin, may be applied to the recycled plastic product. The softened veneer is then wrapped around the plastic product, over a plurality of sides. Given the tensile strength, compressive strength, and shear strength of the recycled plastic filling, once the plastic is encased in a wood-like veneer, and cooled, the final product may function as a suitable wood replacement. Some examples of the product's uses include, but are not limited to cabinets, countertops, skateboard decks, plywood for structural framing, shower trays and other fixtures used in wet and moist environments, doors, roof tiles, solar panels, exterior building trims, deck, and railing system, 3-in-1 decorative thermal insulation (light, sound, thermal), baseboards, and indoor and outdoor construction material including, but not limited to non-load bearing studs.

Polywood is particularly advantageous because it is impact resistant and has a compressive strength twenty times greater than the PET foam filling 102. It, therefore, provides the board with impact, and scratch-resistant properties.

### Cabinets

For example, the product is an ideal construction material for cabinet fabrication, particularly because in some embodiments, the product may be strong and durable, yet approximately 50% lighter than natural wood. Furthermore, the polywood veneer provides an impact-resistant coating, preventing dents, scratches, and damage to the material. Additionally, the product may be installed with traditional cabinet installation tools including, but not limited to, a saw, clamps, a drill, and a nail gun. Due to the lightweightness of the product, the cabinets can be easily installed by novices, such as users and homeowners, rather than by professionals. The herein described blown foam boards may be particularly useful for use in wall-mounted cabinets because the lightweight yet sturdy properties make the foam board-based cabinets ideal for wall installation without relying on the floor, or other under-mounted supports. The product may also be ideal for use in fabricating floor-mounted cabinets and base cabinets, which sit under sinks because the material is water-resistant and will not deteriorate when wet. While such cabinets may be fashioned and installed with traditional means known to those having ordinary skill in the art, cabinets bearing a polywood veer can be laminated to each other using a toluene solvent-based glue or via heat compression, at temperatures above 90 degrees Celsius. Preferably heating does not exceed 120 degrees Celsius, or more preferably 200 degrees, to avoid damaging properties of the material.

### Fashioning a Cabinet Box

The following process is illustrative in nature and not intended to limit the process of producing cabinets fashioned from the materials produced and disclosed herein. Referring to the drawings, wherein like reference numerals represent like elements, there is shown in FIG. 2 an isometric view of a series of cabinets constructed in accordance with the materials presented in this disclosure. Plastic sheets, or foam sheets, coated with a wood like veneer 100, as described herein, may be fashioned into lightweight, yet sturdy cabinet boxes 106 containing load-bearing shelves 108 fabricated from the same material.

A cabinet may be fashioned from a cabinet box 106 (also known as the cabinet case).

The box shape may be constructed from two side panels 110 and 112, a top panel 114, a bottom panel 116, and a back panel 118. While the panels are traditionally made from wood or particle board, thermoplastic materials may be a superior material for cabinet box fabrication. In some embodiments, the panels of the cabinet box may be fastened to each other with joinery. Depending on the type of joinery used the cabinet box may have exposed or mitered edges.

While cabinet boxes fashioned from the thermoplastics material(s) may use traditional wood fastening materials, such as but not limited to, joinery, they may also be laminated to each other using a toluene solvent-based glue 122, or via heat compression at temperatures exceeding 90 degrees Celsius. Doors may be mounted to the cabinet box using standard hinges 124 including but not limited to, full and partial wraparound hinges, flush mount hinges, inset hinges, surface mount hinges, semi-concealed hinges, T-style hinges, butt hinges, soft close hinges, self-open hinges, self-close hinges. and full or partial overlay European hinges.

Five separate rectangular boards, including but not limited to boards constructed from the herein described product, may be attached to form a cabinet box. As seen in FIG. 2, parallel top 114 and bottom 116 pieces cut to the same size may be fixed to two parallel side pieces 110 and 112, such that the two parallel side pieces fix top piece 114 to bottom piece 116. It is preferable that the two parallel side pieces, right side piece 110 and left side piece 112 be cut to the same size as another, but not necessarily to the same size as top piece 114 and bottom piece 116. The side pieces' width should mirror the length of the top and bottom pieces. Back piece 118, may preferably have the same length dimensions right side piece 110 and left side piece 112 and the same width dimensions as top piece 114 and bottom piece 116. It is preferable that bottom 120 of back piece 118 be coupled to bottom piece 116, and back piece sides 121 be coupled to right side piece 110 and left side piece 112. Each separate piece may be attached with traditional joiners, laminated to each other with a toluene solvent-based glue, or attached via heat compression at temperatures exceeding 90 degrees Celsius. Adjacent panels may be coupled one another similarly via joiners, glue solvent, or heat compression. Sample dimensions for a standard cabinet box include but are not limited to, top and bottom pieces having a length of fourteen inches and a width of twenty-four inches, side pieces having a length of thirty inches and a width of fourteen inches, and a back piece having a length of thirty inches and a width of twenty-four inches.

When preparing the panels for attachment, proper safety precautions should be taken, including, but not limited to, wearing glasses and earplugs while using the saw, using a system for collecting sawdust, and ensuring that the table saw blade is square with the table. Because the veneer may be produced with a wood grain finish, for a continuous wood grain look, side panels 110 and 112 and back piece 118 are preferably cut with a vertical grain running parallel to the length, and top 114 and bottom 116 pieces may be cut with a horizontal wood grain running perpendicular to the length.

The panels may first be cut, for example with a saw, by making a rip cut. Each panel may be cut to its desired width or length, in a direction parallel to the wood grain. After the rip cuts are complete, the crosscuts may be cut against the grain. If one chooses to use joinery rather than lamination, cuts may be fashioned into the panels for joinery using a CNC machine, a table saw, and/or a series of dowels or dominoes. In other embodiments, the panels may be laminated one to another without the need for joiners. Rather, a toluene-based solvent or heat compression, as described above may be used.

The material may also be useful as a countertop or surface, such as for use with a sink and one or more items. A thermoplastic polymer resin main panel may serve as the countertop surface and structure. The countertop may include two or more layers, and include one or more cut outs adaptable as one or more apertures to allow for a feature (such as a sink, pipe, waste access, etc.) to be set through or thereon. The layers of the countertop may include a central and/or lower surface of foamed thermoplastic resin, bound by heat compression, glue adhesive, or otherwise as a binding to a veneer layer. The one or more cut outs would preferably be set through the two layers. The cut out may be unfinished, such as rough or smooth via sanding, or may be finished with extra veneer, or paint or like molding placed thereover to hide the internal or lower foam layer.

### Shelving

Referring to the drawings, wherein like reference numerals represent like elements, there is shown in FIG. 2, shelving 108, within a cabinet. The shelving may be fabricated from a recycled plastic filling coated in a wood like veneer, as herein described. In some embodiments, the recycled plastic filling may be plastic foam, as seen in FIG. 4. A plastic foam filling is advantageous in that it is lighter than a solid plastic filling, and therefore easier for users to install themselves. Furthermore, plastic foams have a high specific strength. In other embodiments, the shelving may be composed of layers of a wood like, thermoplastic elastomer laminated to each other with a toluene solvent-based glue or attached via heat compression at temperatures exceeding ninety degrees Celsius, without the need for a plastic filling.

Such shelving may function as fixed shelving 108, within a cabinet, or as floating shelves. Because the material is water resistant it is particularly useful in moist places such as bathrooms and kitchens. In other embodiments, it can be used as shelving in pantries, closets, and other storage facilities. Furthermore, because the material is weather resistant and not damaged by UV light, it may serve as shelving in outdoor patios, pools, and backyards.

### Skateboard Decks

In another embodiment, thermoplastic polymer material may be used to produce skateboard decks with a controlled flex system. Such fabrications are ideal because the final product is lightweight, structurally strong, fire-resistant, and UV-inhibited. Additionally, the product is stiff enough to avoid damage, yet flexible enough to absorb impact. The product holds its shape well, producing a satisfactory skateboard “pop”.

In some embodiments, skateboard decks may be produced by sandwiching eight millimeters of recycled plastic material 102 between polywood veneers, preferably the two sets of polywood veneers should be three plies each.

Each layer of polywood may be approximately one seventeenth of an inch thick. Additionally, the polywood should be approximately eight inches wide and thirty-one inches long. The material may be cut using a jigsaw or bandsaw.

The polywood veneers 104 may be laminated to each other with glue containing a toluene solvent or by heat compression at temperatures above ninety degrees Celsius. When using glue to laminate the layers, a thin layer of glue may be applied to the entire top of one veneer and to the entire bottom portion of a second veneer. The two pieces may then be pushed together so that the glue-coated faces make contact. The process may then be repeated for subsequent layers; glue may be applied to the bottom face of the attached veneers and to the top face of a single veneer to attach the single veneer to the attached veneers. It is preferable that glue is evenly spread on both faces in preparation for attachment.

Once the veneers are laminated, each 3-ply product may be attached to the eight millimeter plastic material using epoxy resins or polyester series adhesives. In some embodiments, the three-ply veneers may be a mixture of polywood and other materials, including but not limited to maple wood. In other embodiments, the entire deck may be fashioned from 7 plies of polywood, each layer being one seventeenth of an inch thick, and eliminating the need for a plastic core.

Once the layers are laminated to each other, clamps may be attached around the layers, such that the layers are pressed together while the glue dries. It is preferable that the clamps remain over the layers for approximately four to twenty-four hours. In other embodiments, the layers may be pressed with a hydraulic press for a minimum of four hours, but preferably for twenty-four hours. It is preferable that the skateboard deck cure in a room-temperature space with minimal humidity.

After the deck has cured or cooled, if using heat lamination, the skateboard deck may be cut to its desired shape. Because the deck is comprised of PET and thermoplastics rather than natural wood, it does not need to be sanded. Rather, after shaping the deck may be coated with grip tape, and is subsequently ready for use.

### Other uses

Thermoplastic polymers may also be used as decorative siding, and may additionally replace the need for house wrap, siding, and insulation. The herein described product may be attached to the exterior of a building, in the same manner that vinyl siding is attached, to provide waterproofing, insulation, and decoration to the interior of a building. In some embodiments, the material may have an R-value of 30 when it is 6 inches thick.

The herein described product may also function as roofing material, as it may be shaped into roof tiles, simulated shingles, or roof sheets. In some embodiments, such roofing material may be coated in mylar, or other such material, to reflect solar irradiance and protect the interior of a building from solar heat. In other embodiments, the roofing material may be coated in solar cells, or other such energy-absorbing materials, to function as built-in solar panels.

The herein described product may also replace particle board or plywood as a construction material, function as a baseboard or window trim, or replace traditional decking and railing. The above disclosure is exemplary in nature and not intended to limit the utility of the present invention in any way.

I claim:

1. A composite material comprising:
a. an interior layer comprising a thermoplastic polymer resin, and
b. at least a second layer comprising a veneer encasing said thermoplastic polymer resin, wherein first layer and said second layer are fixed adjacent to one another.

2. The composite material set forth in claim 1 wherein the thermoplastic polymer resin comprises uniform bubble sizes within three hundred percent size relative to one another.

3. The composite material set forth in claim 1 further comprising reinforcing fibers enmeshed in the thermoplastic polymer resin.

4. The composite material set forth in claim 1 wherein the thermoplastic polymer resin is recycled polyethylene terephthalate.

5. The composite material set forth in claim 1 wherein said first layer is coupled to said second layer with an adhesive.

6. The composite material set forth in claim 1 wherein said first layer is coupled to said second layer through heat compression.

7. The composite material set forth in claim 1 wherein said second layer is thin film wrapped around said first layer.

8. The composite material set forth in claim 1 wherein said second layer is comprised of natural wood.

9. A cabinet comprising a multitude of panels, wherein each of said panels comprises a multi-layered thermoplastic polymer resin encased in a thermoplastic elastomer, said cabinet comprising:
a. a side panel comprising a foamed thermoplastic polymer resin coupled to a veneer of thermoplastic elastomer;
b. a face panel comprising a solid thermoplastic polymer veneer layer; and
c. at least one shelf suspended between said side panel and a second side panel.

10. The cabinet set forth in claim 9 wherein said side panel comprises uniform bubble sizes.

11. The cabinet set forth in claim 9 wherein said side panels comprise reinforcing fibers.

12. The cabinet set forth in claim 9 wherein said side panel is coupled to said face panel via a toluene solvent-based glue.

13. The cabinet set forth in claim 9 wherein said side panel is coupled to said face panel via heat compression.

14. The cabinet set forth in claim 11 wherein said face panel comprises a three-dimensional artificial wood vein pattern.

15. A countertop for use with a sink and one or more items; said countertop comprising:
a. a thermoplastic polymer resin main panel comprises at least two layers;
b. one or more cut outs adaptable as one or more apertures to allow for a feature to be set through or thereon;
c. a binding between said two layers;
d. wherein said one or more cut outs are set through said at least two layers.

16. The countertop of claim 15 wherein said at least two layers are bound by a toluene-based adhesive.

17. The countertop of claim 15 wherein said at least two layers are bound by heat compression.

18. The countertop of claim 15 further comprising a three-dimensional surface texture applied over a top side.
